(19) United States
(12) Patent Application Publication
(10) Pub. No.: US 2015/0335056 A1
(43) Pub. Date: Nov. 26, 2015

(54) Liquid Refreshment for Consumption Post Athletic Activity

(71) Applicants: Aaron Goldman, Lansdowne, VA (US); Zachary Goldman, Lansdowne, VA (US); Isaac Goldman, Lansdowne, VA (US); Ilana Goldman, Lansdowne, VA (US)

(72) Inventors: Aaron Goldman, Lansdowne, VA (US); Zachary Goldman, Lansdowne, VA (US); Isaac Goldman, Lansdowne, VA (US); Ilana Goldman, Lansdowne, VA (US)

(21) Appl. No.: 14/287,170

(22) Filed: May 26, 2014

(51) Int. Cl. A23L 2/52

(52) U.S. Cl. CPC A23L 2/52; A23V 2002/00

(57) ABSTRACT

This liquid refreshment designed to replace key nourishment elements after rigorous physical activity can be used for a wide variety of nutritional needs. Our refreshment does not contain artificial ingredients, preservatives, added sugars, and foods from concentrate. Our refreshment consists of 1.5 cups of freshly squeezed orange juice, 1.5 cups of freshly squeezed lemon juice, 12 cups of filtered water, 6 table spoons of pure honey, and 20 drops of sea water. An embodiment of the recipe is the mixing of all ingredients until the honey is no longer viscous. The ingredients are added in any order and the liquid is refrigerated when not consumed. This drink is effective at replenishing electrolytes in the human body.

### BACKGROUND

1. Field of the Invention

The present invention is a recipe for a drink to replace key nourishment elements after rigorous physical activity but can be used for a wide variety of nutritional needs.

2. Description of the Related Art

Existing sports drinks are full of artificial ingredients, preservatives, added sugars, and foods from concentrate. Those drinks are designed to be mass produced and have a long shelf life but they are not as effective as all natural ingredients. Moreover, the various artificial ingredients have unknown long term side effects not present in our recipe.

### SPECIFICATION

The recipe is stated as follows to make approximately 1 gallon of the drink:
1) 1.5 cups of freshly squeezed orange juice
2) 1.5 cups of freshly squeezed lemon juice
3) 12 cups of filtered water
4) 6 table spoons of pure honey
5) 20 drops of sea water

An embodiment of the recipe is the mixing of all ingredients until the honey is no longer viscous. The ingredients are added in any order and the liquid is refrigerated when not consumed.

1. This drink is effective at replenishing electrolytes in the human body.

2. This drink can remain fresh and effective for weeks after it is created without the use of artificial additives or preservatives.

3. This drink uses no added sugars and only contains natural sugar present in the other ingredients.
